(19) United States
(12) Patent Application Publication
(10) Pub. No.: US 2001/0046628 A1
(43) Pub. Date: Nov. 29, 2001

(54) Coated lithium mixed oxide particles and a process for producing them

(75) Inventors: Ruediger Oesten, Weiterstadt (DE); Bangyin Li, Iwaki-shi (JP); Nobuaki Nakamura, Iwaki-shi (JP); Katsuhisa Nitta, Iwaki-shi (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 09/816,663

(22) Filed: Mar. 26, 2001

(30) Foreign Application Priority Data
Mar. 24, 2000 (DE) 100 14 884.0

(51) Int. Cl. H01M 4/48; H01M 4/50; H01M 4/52; C01F 7/04; C01G 23/04; C01G 37/14; C01G 49/02; C01G 51/04; C01G 53/04

(52) U.S. Cl. 429/231.1; 429/224; 429/231.2; 429/231.3; 429/223; 429/220; 429/221; 429/231.5; 429/231.6; 423/594; 423/596; 423/593; 423/598; 423/599; 423/600

(57) ABSTRACT

The invention relates to lithium mixed oxide particles coated with one or more layers of alkali metals and metal oxides for improving the properties of electrochemical cells.

The invention relates to lithium mixed oxide particles which have been coated with one or more layers of alkali metal compounds and metal oxides for improving the properties of electrochemical cells.

There is a high demand for rechargeable lithium batteries and this will increase greatly in the future. This is because of the high achievable energy density and the low weight of these batteries. These batteries are employed in mobile telephones, portable video cameras, laptops, etc.

It is known that the use of metallic lithium as anode material leads, owing to dendrite formation on dissolution and deposition of the lithium, to the battery being able to perform acceptably over an unsatisfactory number of cycles and to a considerable safety risk (internal short circuit) (J. Power Sources, 54 (1995) 151).

A solution to these problems was achieved by replacement of the lithium metal anode by other compounds which can reversibly intercalate lithium ions. The functional principle of the lithium ion battery is based on both the cathode materials and the anode materials being able to intercalate lithium ions reversibly, i.e. on charging, the lithium ions migrate from the cathode, diffuse through the electrolyte and are intercalated in the anode. On discharge, the same process proceeds in the reverse direction. Owing to this mode of operation, these batteries are also known as “rocking chair” batteries or lithium ion batteries.

The resulting voltage of such a cell is determined by the difference of the lithium intercalation potentials of the electrodes. In order to achieve a very high voltage, it is necessary to use cathode materials which intercalate lithium ions at very high potentials and anode materials which intercalate lithium ions at very low potentials (vs. Li/Li⁺). Cathode materials which meet these requirements are LiCoO₂ and LiNiO₂, which have sheet structures, and LiMn₂O₄, which has a three-dimensional cubic structure. These compounds deintercalate lithium ions at potentials of about 4V (vs. Li/Li⁺). In the case of the anode compounds, certain carbon compounds such as graphite meet the requirements of a low potential and a high capacity.

At the beginning of the 1990s, Sony brought on to the market a lithium ion battery which consists of a lithium cobalt oxide cathode, a non-aqueous liquid electrolyte and a carbon anode (Progr. Batteries Solar Cells, 9 (1990) 20).

For 4V cathodes, LiCoO₂, LiNiO₂ and LiMn₂O₄ have been discussed and used. Electrolytes used are mixtures which comprise aprotic solvents in addition to an electrolyte salt. The most frequently used solvents are ethylene carbonate (EC), propylene carbonate (PC), dimethyl carbonate (DMC), diethyl carbonate (DEC) and ethyl methyl carbonate (EMC). Although a whole series of electrolyte salts have been discussed, LiPF₆ is used almost without exception. The anode used is generally graphite.

A disadvantage of the state-of-the-art batteries is that the storage life and cyclability at high temperatures is poor. The reasons for this are both the electrolyte and the cathode materials used, in particular the lithium-manganese spinel LiMn₂O₄.

However, the lithium-manganese spinel is a very promising material as cathode for appliance batteries. The advantage over LiNiO₂- and LiCoO₂-based cathodes is the improved safety in the charged state, the lack of toxicity and the lower raw material cost.

Disadvantages of the lithium manganese spinel are its lower capacity and its unsatisfactory high-temperature storage life and the associated poor cyclability at high temperatures. The reason for this is believed to be the solubility of divalent manganese in the electrolyte (Solid State Ionics 69 (1994) 59; J. Power Sources 66 (1997) 129; J. Electrochem. Soc. 144 (1997) 2178). In the spinel LiMn₂O₄, the manganese is present in two oxidation states, namely trivalent and tetravalent. The LiPF₆-containing electrolyte always contains some water contamination. This water reacts with the electrolyte salt LiPF₆ to form LiF and acid components, e.g. HF. These acid components react with the trivalent manganese in the spinel to form Mn²⁺ and Mn⁴⁺ (disproportionation: 2Mn³⁺→Mn²⁺+Mn⁴⁺) This degradation takes place even at room temperature, but accelerates with increasing temperature.

One way of increasing the stability of the spinel at high temperatures is to dope it. For example, some of the manganese ions can be replaced by other, for example trivalent metal cations. Antonini et al. report that spinels doped with gallium and chromium (for example Li_{1.02}Ga_{0.025}Cr_{0.025}Mn_{1.95}O₄) display a satisfactory storage life and cyclability at 55° C. (J. Electrochem. Soc, 145 (1998) 2726).

A similar route has been followed by the researchers of Bellcore Inc. They replace part of the manganese by aluminium and, in addition, part of the oxygen ions by fluoride ions ((Li₁₊ₓAl_{y}Mn_{2-x-y})O_{4-z}F_{z}). This doping, too, leads to an improvement in the cyclability at 55° C. (WO/9856057).

Another approach comprises modifying the surface of the cathode material. U.S. Pat. No. 5,695,887 proposes spinel cathodes which have a reduced surface area and whose catalytic centres are masked by treatment with chelating agents, e.g. acetylacetone. Such cathode materials display significantly reduced self-discharge and an improved storage life at 55° C. The cyclability at 55° C. is improved only slightly (Solid State Ionics 104 (1997) 13).

A further possibility is to coat the cathode particles with a layer, for example a lithium borate glass (Solid State Ionics 104 (1997) 13). For this purpose, a spinel is added to a methanolic solution of H₃BO₃, LiBO₂*8H₂O and LiOH*H₂O and stirred at 50-80° C. until the solvent has completely evaporated. The powder is subsequently heated at 600-800° C. to complete the conversion into the borate. This improves the storage life at high temperatures, but improved cyclability was not found.

In WO 98/02930, undoped spinels are treated with alkali metal hydroxide solutions. The treated spinel is subsequently heated in a CO₂ atmosphere to convert the adhering hydroxides into the corresponding carbonates. The spinels which have been modified in this way display an improved high-temperature storage life and also improved cyclability at high temperatures.

Coating electrodes to improve various properties of lithium ion batteries has been described many times.

For example, the cathode and/or anode are/is coated by applying the active material together with binder and a conductive material as paste to the terminal lead. Subsequently, a paste consisting of the coating material, binder and/or solvent is applied to the electrode. Coating materials mentioned are inorganic and/or organic materials, which may be conductive, e.g. Al₂O₃, nickel, graphite, LiF, PVDF etc. Lithium ion batteries comprising such coated electrodes display high voltages and capacities and improved safety characteristics (EP 836238).

A very similar procedure is also used in U.S. Pat. No. 5,869,208. Here too, the electrode paste (cathode material: lithium-manganese spinel) is first produced and applied to the terminal lead. The protective layer, consisting of a metal oxide and binder, is then applied as paste to the electrode. Metal oxides used are, for example, aluminium oxide, titanium oxide and zirconium oxide.

In JP 08236114, the electrode is likewise produced first, preferably using LiNi_{0.5}Co_{0.5}O₂ as active material, and an oxide layer is then applied by sputtering, vacuum vapor deposition or CVD.

In JP 09147916, a protective layer consisting of solid oxide particles, for example MgO, CaO, SrO, ZrO₂, Al₂O₃, SiO₂ and a polymer is applied to that side of the terminal lead which comprises the electrode. In this way, high voltages and a high cyclability are achieved.

Another route is followed in JP 09165984. The cathode material employed is the lithium-manganese spinel which is coated with boron oxide. This coating is produced during the synthesis of the spinel. For this purpose, a lithium compound, a manganese compound and a boron compound are calcined in an oxidizing atmosphere. The resulting spinels coated with boron oxide display no manganese dissolution at high voltages.

However, not only oxidic materials but also polymers are used for producing the coating, as described in JP 07296847 for improving the safety characteristics. JP 08250120 uses sulfides, selenides and tellurides for coatings to improve the cycling performance and JP 08264183 uses fluorides for coatings to improve the cycling life.

The present invention provides electrode materials which have improved stability towards acids, without the disadvantages of the prior art.

Thus, the invention provides lithium mixed oxide particles which are coated with alkali metal compounds and metal oxides.

The invention also provides a process for coating the lithium mixed oxide particles and provides for the use in electrochemical cells, batteries, secondary lithium batteries and supercapacitors.

The invention provides a process for producing singly or multiply coated lithium mixed oxide particles, characterized in that

a) the particles are suspended in an organic solvent or water,

b) an alkali metal salt compound suspended in an organic solvent or water is added,

c) metal alkoxides, metal salt or metal sol dissolved in an organic solvent or water are added,

d) the suspension is admixed with a hydrolysis solution and

e) the coated particles are filtered off, dried and calcined.

The present invention includes as uncoated materials, undoped and doped mixed oxides as cathode materials, e.g., cathodes formed from LiMn₂O₄, LiₓM_{y}Mn_{2-y}O₄, where M is selected from the group consisting of Ti, Ge, Fe, Co, Cr, Cu, Li, Al, Mg, Ga, Zn, Ni and V, LiNiO₂, LiCoO₂, LiM_{y}Co_{1-y}O₂, where M is selected from the group consisting of Fe, B, Si, Cu, Ce, Y, Ti, V, Sn, Zr, La, Ni, Al, Mg, Cr and Mn, LiM_{y}Ni_{1-y}O₂, where M is selected from the group consisting of Fe, Al, Ti, V, Co, Cu, Zn, B, Mg, Cr and Mn, LiₓWO₃, LiₓTiS₂, wherein 0.9≦x<1.1 and 0≦1. The present invention likewise includes as uncoated materials any lithium intercalation and insertion compounds which are suitable for 4V cathodes, e.g., as disclosed in J. Goodenough, “Oxide engineering for advanced power sources”, pages 1-14 and M.S. Wittingham, “25 years of intercalation chemistry for battery materials”, pages 15-28 in “Intercalation Compounds for Battery Materials”, ed by G. -A. Nazri et al., The Electrochemical Society, Inc., PV 99-24, Pennington, N.J., USA, 2000. The invention further comprises production and use of these materials coated as described, in particular as cathode materials in electrochemical cells.

In the present invention, the lithium mixed oxide particles are coated with mixtures of alkali metal compounds and metal oxides to obtain improved stability towards acids.

Any metal oxide or mixture of metal oxides capable of reacting with alkali metal to form a mixed oxide can be used. Suitable coating materials are mixtures comprising various metal oxides, in particular oxides or mixed oxides of elements selected from the group consisting of Zr, Al, Si, Ti, La, Y, Sn, Zn, Mg, Ca and Sr and their mixtures. Mixtures comprising various metal oxides, in particular oxides or mixed oxide are made from their metal alkoxides.

The alkali metals can be made available from suitable salts. For example, lithium, sodium, potassium, rubidium and caesium acetates, acetylacetonates, lactates, oxalates, salicylates and stearates, nitrates, sulfates or halogenides can be used.

It has been found that the weight ratio of the metal oxide to coated lithium mixed oxide particles in the cathod is from 0.01 to 20%, preferably from 0.1 to 10%. It has been found that the weight ratio of the alkali metal to coated lithium mixed oxide particles in the cathode is from 0.01 to 10%, preferably from 0.1 to 5%.

It has been found that coating with the said mixtures of alkali metal compounds and metal oxides can greatly inhibit the undesirable reactions of acids with the electrode materials.

It has surprisingly been found that coating a conventional lithium-manganese spinel can prevent leaching of Mn by acids such as HF and acetic acid.

Furthermore, it has been found that coating the individual particles has a number of advantages compared with coating the electrode strips. If the electrode material is damaged in the case of coated strips, the electrolyte can attack a large part of the active material, while when it is the individual particles which are coated, these undesirable reactions remain very localized. Coating of individual particles can be performed by the technique disclosed in DE 19 922 522, DE 19 946 066 or DE 10 014 884.

The lithium mixed oxide particles can be coated with one or more layers.

The coated lithium mixed oxide particles can be processed together with the customary support materials and auxiliaries to produce 4V cathodes for lithium ion batteries.

In addition, the coating process is carried out by the supplier, so that the battery manufacturer does not have to make the process changes necessary for the coating step.

Coating of the materials is also expected to improve the safety aspects.

The cathode material of the invention can be used in secondary lithium ion batteries using customary electrolytes. Suitable electrolytes are, for example, those comprising electrolyte salts selected from the group consisting of LiPF₆, LiBF₄, LiClO₄, LiAsF₆, LiCF₃SO₃, LiN(CF₃SO₂)₂ or LiC(CF₃SO₂)₃ and mixtures thereof. The electrolytes can further comprise organic isocyanates (DE 199 44 603) to reduce the water content. Likewise, the electrolytes may comprise organic alkali metal salts (DE 199 10 968) as additive. Suitable alkali metal salts are alkali metal borates of the general formula

Li⁺B⁻(OR¹)ₘ(OR²)ₚ

where

m and p are 0, 1, 2, 3 or 4 with m+p=4 and

R¹ and R² are identical or different,

if desired are bound directly to one another by a single or double bond,

in each case individually or together are an aromatic or aliphatic carboxylic acid, dicarboxylic acid or sulfonic acid group, or

in each case individually or together are an aromatic, ring selected from the group consisting of phenyl, naphthyl, anthracenyl or phenanthrenyl, which may be unsubstituted or monosubstituted to tetrasubstituted by A or Hal, or

in each case individually or together are a heterocyclic aromatic ring selected from the group consisting of pyridyl, pyrazyl or bipyridyl, which may be unsubstituted or monosubtituted to trisubstituted by A or Hal, or

in each case individually or together are an aromatic hydroxy acid selected from the group consisting of aromatic hydroxycarboxylic acids or aromatic hydroxysulfonic acids, which may be unsubstituted or monosubstituted to tetrasubstituted by A or Hal, and

Hal is F, Cl or Br and

A is alkyl having from 1 to 6 carbon atoms, which may be monohalogenated to trihalogenated. Other suitable alkali metal salts are alkali metal alkoxides of the general formula

Li⁺OR⁻

where R

is an aromatic or aliphatic caroboxylic acid, dicarboxylic acid or sulfonic acid group, or

is an aromatic ring selected from the group consisting of phenyl, naphthyl, anthracenyl or phenanthrenyl, which may be unsubstituted or monosubstituted to tetrasubstituted by A or Hal, or

is a heterocyclic aromatic ring selected from the group consisting of pyridyl, pyrazyl or bipyridyl, which may be unsubstituted or monosubstituted to trisubstituted by A or Hal, or

is an aromatic hydroxy acid selected from the group consisting of aromatic hydroxycarboxylic acids or aromatic hydroxysulfonic acids, which may be unsubstituted or monosubstituted to tetrasubstituted by A or Hal, and

Hal is F, Cl or Br, and

A is alkyl having from 1 to 6 carbon atoms which may be monohalogenated to trihalogenated.

It is also possible for lithium complex salts of the formula

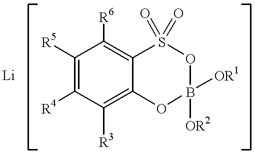

where

R¹ and R² are identical or different, if desired are bound directly to one another by a single or double bond,

in each case individually or together are an aromatic ring selected from the group consisting of phenyl, naphthyl, anthracenyl or phenanthrenyl, which may be unsubstituted or monosubstituted to hexasubstituted by alkyl (C₁ to C₆), alkoxy groups (C₁ to C₆) or halogen (F, Cl, Br),

or in each case individually or together are an aromatic heterocyclic ring selected from the group consisting of pyridyl, pyrazyl or pyrimidyl, which may be unsubstituted or monosubstituted to tetrasubstituted by alkyl (C₁ to C₆), alkoxy groups (C₁ to C₆) or halogen (F, Cl, Br),

or in each case individually or together are an aromatic ring selected from the group consisting of hydroxybenzenecarboxyl, hydroxynaphthalenecarboxyl, hydroxybenzenesulfonyl and hydroxynaphthalenesulfonyl, which may be unsubstituted or monosubstituted to tetrasubstituted by alkyl (C₁ to C₆), alkoxy groups (C₁ to C₆) or halogen (F, Cl, Br),

and R³-R⁶ may in each case individually or in pairs, if desired be bound directly to one another by a single or double bond, have one of the following meanings:

1. alkyl (C₁ to C₆), alkyloxy (C₁ to C₆) or halogen (F, Cl, Br)

2. an aromatic ring selected from among the groups

phenyl, naphthyl, anthracenyl and phenanthrenyl, which may be unsubstituted or monosubstituted to hexasubstituted by alkyl (C₁ to C₆), alkoxy groups (C₁ to C₆) or halogen (F, Cl, Br),

pyridyl, pyrazyl and pyrimidyl, which may be unsubstituted or monosubstituted to tetrasubstituted by alkyl (C₁ to C₆), alkoxy groups (C₁ to C₆) or halogen (F, Cl, Br),

which are prepared by the following method (DE 199 32 317):

a) 3-, 4-, 5-, 6-substituted phenol is admixed with chlorosulfonic acid in a suitable solvent,

b) the intermediate from a) is reacted with chlorotrimethylsilane, filtered and fractionally distilled,

c) the intermediate from b) is reacted with lithium tetramethoxyborate(1-) in a suitable solvent and the end product is isolated therefrom, to be present in the electrolyte.

The electrolytes may likewise comprise compounds of the following formula (DE 199 41 566)

[([R¹(CR²R³)ₖ]₁Aₓ)_{y}Kt]^{+ -}N(CF₃)₂

where

Kt=N, P, As, Sb, S, Se

A=N, P, P(O), O, S, S(O), SO₂, As, As(O), Sb, Sb(O)

R¹, R² and R³ are

identical or different and are each

H, halogen, substituted and/or unsubstituted alkyl CₙH₂ₙ₊₁, substituted and/or unsubstituted alkenyl having 1-18 carbon atoms and one or more double bonds, substituted and/or unsubstituted alkynyl having 1-18 carbon atoms and one or more triple bonds, substituted and/or unsubstituted cycloalkyl CₘH₂ₘ₋₁, monosubstituted or polysubstituted and/or unsubstituted phenyl, substituted and/or unsubstituted heteroaryl,

A can be included in various positions in R¹, R² and/or R³,

Kt can be included in cyclic or heterocyclic rings,

the groups bound to Kt may be identical or different

where

n=1-18,

m=3-7,

k=0, 1-6,

l=1 or 2 in the case of x=1 and 1 in the case of x=0,

x=0, 1,

y=1-4.

The process for preparing these compounds is characterized in that an alkali metal salt of the general formula

D^{+ -}N(CF₃)₂

where D⁺ is selected from the group consisting of the alkali metals, is reacted in a polar organic solvent with a salt of the general formula

[([R¹(CR²R³)ₖ]₁Aₓ)_{y}Kt]^{+ -}E

where

Kt, A, R¹, R², R³, k, l, x and y are as defined above and

⁻E is F⁻, Cl⁻, Br⁻, I⁻, BF₄⁻, ClO₄⁻, AsF₆⁻, SbF₆⁻ or PF₆⁻.

In addition, it is possible to use electrolytes comprising compounds of the general formula (DE 199 53 638)

X—(CYZ)ₘ-SO₂N(CR¹R²R³)₂

where

x is H, F, Cl, CₙF₂ₙ₊₁, CₙF₂ₙ₋₁, (SO₂)ₖN(CR¹R²R³)₂

Y is H, F, Cl,

z is H, F, Cl,

R¹, R², R³ are H and/or alkyl, fluoroalkyl, cycloalkyl

m is 0-9 and, if X=H, m≠0,

n is 1-9,

k is 0 if m=0 and k=1 if m=1-9,

prepared by the reaction of partially fluorinated or perfluorinated alkylsulfonyl fluorides with dimethylamine in organic solvents, and also complex salts of the general formula (DE 199 51 804)

M^{x+}[EZ]_{x/y}^{y-}

where:

x, y are 1, 2, 3, 4, 5, 6,

M^{x+} is a metal ion,

E is a Lewis acid selected from the group consisting of

BR¹R²R³, AlR¹R²R³, PR¹R²R³R⁴R⁵, AsR¹R²R³R⁴R⁵, VR¹R²R³R⁴R⁵

R¹ to R⁵ are identical or different, if desired are bound directly to one another by a single or double bond, in each case individually or together are

a halogen (F, Cl, Br),

an alkyl or alkoxy radical (C₁ to C₈) which may be partially or fully substituted by F, Cl, Br,

an aromatic ring, if desired bound via oxygen, selected from the group consisting of phenyl, naphthyl, anthracenyl and phenanthrenyl, which may be unsubstituted or monosubstituted to hexasubstituted by alkyl (C₁ to C₈) or F, Cl, Br,

an aromatic heterocyclic ring, if desired bound via oxygen, selected from the group consisting of pyridyl, pyrazyl and pyrimidyl, which may be unsubstituted or monosubstituted to tetrasubstituted by alkyl (C₁ to C₈) or F, Cl, Br, and

Z is OR⁶, NR⁶R⁷, CR⁶R⁷R⁸, OSO₂R⁶, N(SO₂R⁶)(SO₂R⁷), C(SO₂R⁶) (SO₂R⁷) (SO₂R⁸) OCOR⁶, where

R⁶ to R⁸ are identical or different, if desired are bound directly to one another by a single or double bond, and in each case individually or together are

hydrogen or as defined for R¹ to R⁵,

prepared by reaction of an appropriate boron or phosphorus Lewis acid-solvent adduct with a lithium or tetraalkylammonium imide, methanide or triflate.

Borate salts (DE 199 59 722) of the general formula

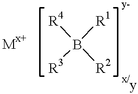

where:

M is a metal ion or tetraalkylammonium ion,

x,y are 1, 2, 3, 4, 5 or 6,

R¹ to R⁴ are identical or different alkoxy or carboxyl radicals (C₁-C₈) which may, if desired, be bound directly to one another by a single or double bond, can also be present. These borate salts are prepared by reaction of lithium tetralkoxyborate or a 1:1 mixture of lithium alkoxide with a boric ester in an aprotic solvent with a suitable hydroxyl or carboxyl compound in a ratio of 2:1 or 4:1.

A general example of the invention is described below.

4V cathode materials, in particular materials selected from the group consisting of LiMn₂O₄, LiₓM_{y}Mn_{2-y}O₄, where M is selected from the group consisting of Ti, Ge, Fe, Co, Cr, Cu, Li, Al, Mg, Ga, Zn, Ni and V, LiNiO₂, LiCoO₂, LiM_{y}Co_{1-y}O₂, where M is selected from the group consisting of Fe, B, Si, Cu, Ce, Y, Ti, V, Sn, Zr, La, Ni, Al, Mg, Cr and Mn, LiM_{y}Ni_{1-y}O₂, where M is selected from the group consisting of Fe, Al, Ti, V, Co, Cu, Zn, B, Mg, Cr and Mn, LiₓWO₃, LiₓTiS₂, are suspended in polar organic solvents such as alcohols, aldehydes, halides or ketones. Alkali metal salts, preferably selected from the group consisting of lithium, sodium, potassium, rubidium and caesium acetates, acetylacetonates, lactates, oxalates, salicylates and stearates, suspended in polar organic solvents such as alcohols, aldehydes, halides or ketones are added. The materials can also be suspended in non-polar organic solvents such as cycloalkanes or aromatics. The reaction vessel is heatable and equipped with a stirrer and/or baffle plates. The reaction is carried out under an inert gas atmosphere. The reaction solution is heated to temperatures in the range from 10 to 100° C., depending on the boiling point of the solvent.

A solution of metal alkoxides selected from the group consisting of Zr(OR)₄, Al(OR)₃, Si(OR)₄, Ti(OR)₄, La(OR)₃, Y (OR)₃, Sn(OR)₄, Zn(OR)₂, Mg(OR)₂, Ca(OR)₂ and Sr(OR)₂ and mixtures thereof, where R are identical or different and are C₁- to C₄-alkyl groups and/or partly a chelating agent such as acetylacetone and ethylacetylacetone etc., in a polar organic solvent, e.g. alcohols, aldehydes, halides or ketones, is added.

A further possibility is 4V cathode materials suspended in water is stirred and heated to temperatures in the range from 10 to 100° C. Alkali metal salts, preferably selected from the group consisting of lithium, sodium, potassium, rubidium and caesium acetates, acetylacetonates, lactates, oxalates, salicylates and stearates, suspended in polar organic solvents such as alcohols, aldehydes, halides or ketones are added. The materials can also be suspended in non-polar organic solvents such as cycloalkanes or aromatics. A metal sol or metal salt selected from the group consisting of Zr, Al, Si, Ti, La, Y, Sn, Zn, Mg, Ca and Sr and mixtures thereof is added slowly into the suspension by simultaneous addition of 0.5-5%, preferably 1%, LiOH aqueous solution.

Suitable hydrolysis solutions are, depending on the solvent used for the coating solution, acids, bases or their aqueous solutions or water. The hydrolysis solution is metered in slowly. The amounts metered in and the addition rates depend on the metal salts used. In order to ensure that the hydrolysis reaction proceeds quantitatively, the hydrolysis solution is added in excess.

The hydrolysis can also be carried out simultaneously with the addition of the metal alkoxide, depending on the type of metal alkoxide.

After the reaction is complete, the solution is removed by filtration and the powder obtained is dried. To ensure complete conversion into the metal oxide, the dried powder has to be calcined. The resulting powder is heated to from 300° C. to 900° C., preferably from 500 to 780° C., and held at this temperature for from 10 minutes to 24 hours.

In the foregoing and in the following examples, all temperatures are set forth uncorrected in degrees Celsius; and, unless otherwise indicated, all parts and percentages are by weight.

The entire disclosure of all applications, patents and publications, cited above and below, and of corresponding German Application No. 100 14 884.0, filed Mar. 24, 2000 is hereby incorporated by reference.

### EXAMPLES

### Example 1

Coating of Cathode Materials

600 g of lithium-manganese spinel, SP35 Selectipur® from Merck, are dispersed in 2200 g of anhydrous ethanol, and the suspension is heated to 45° C. and stirred under an N₂ atmosphere. 61.22 g of lithium acetate dissolved in 300 g of anhydrous ethanol are added. After 10 minutes, a solution of 20.10 g of Zr(O-nC₃H₇)₄ in 402 g of anhydrous ethanol is added. After 30 minutes, 60 g of deionized water in 240 g of anhydrous ethanol are added slowly (2 ml/min). 12 hours after the commencement of the hydrolysis, the product is filtered off and dried for 2 hours at 110° C. The dried product is calcined at 500° C. for half an hour. The product is an LiMn₂O₄ coated with lithium-containing zirconium oxide.

### Example 2

### Comparative Example

600 g of LiMn₂O₄, SP35 Selectipur® from Merck, are dispersed in 2200 g of anhydrous ethanol, and the suspension is heated to 45° C. and stirred under an N₂ atmosphere. A solution of 20.10 g of Zr(O-nC₃H₇)₄ dissolved in 402 g of anhydrous ethanol is added. After 30 minutes, 60 g of deionized water in 240 g of anhydrous ethanol are added slowly (2 ml/min). 12 hours after the commencement of the hydrolysis reaction, the product is filtered off and dried for 2 hours at 110° C. The dried product is calcined at 500° C. for half an hour. The product is an LiMn₂O₄ coated with 1.0% by weight of zirconium oxide.

### Example 3

Coating of Cathode Materials

600 g of LiMn₂O₄, SP35 Selectipur® from Merck, are dispersed in 2200 g of anhydrous isopropyl alcohol, and the suspension is heated to 45° C. and stirred under an N₂ atmosphere. 30.61 g of lithium acetate dissolved in 300 g of anhydrous ethanol are added. After 10 minutes, a solution of 32.41 g of Al(O-isoC₃H₇)₂[OC(CH₃)═CHCOOC₂H₅] in 324 g of anhydrous isopropyl alcohol is added slowly (2.3 ml/min). At the same time, 63.61 g of deionized water in 144 g of anhydrous isopropyl alcohol are added slowly (1.4 ml/min). 12 hours after the commencement of the hydrolysis reaction, the product is filtered off and dried for 2 hours at 110° C. The dried product is calcined at 700° C. for half an hour. The product is an LiMn₂O₄ coated with lithium-containing aluminium oxide.

### Example 4

### Comparative Example

600 g of LiMn₂O₄, SP35 Selectipur® from Merck, are dispersed in 2200 g of anhydrous isopropyl alcohol, and the suspension is heated to 45° C. and stirred under an N₂ atmosphere. A solution of 32.41 g of Al(O-isoC₃H₇)₂[OC(CH₃)═CHCOOC₂H₅] in 324 g of anhydrous isopropyl alcohol is added slowly (2.3 ml/min). At the same time, 63.61 g of deionized water in 144 g of anhydrous isopropyl alcohol are added slowly (1.4 ml/min). 12 hours after the commencement of the hydrolysis reaction, the product is filtered off and dried for 2 hours at 110° C. The dried product is calcined at 700° C. for half an hour. The product is an LiMn₂O₄ coated with 1.0% by weight of aluminium oxide.

### Example 5

Coating of Cathode Material

600 g of LiMn₂O₄, SP35 Selectipur® from Merk, are dispersed in 3125 g water, and the suspension is heated to 45° C. and stirred. The stirring and temperature is kept till the end of reaction. 12 g of lithium acetate is dissolved in 250 g of 1% acetic acid solution separately. This solution is added into the susupension. By this addition the pH of the susupension become 5.5. Then 600 g of alumina sol (particle radius 20-200A ,solid content 1%) is added slowly into the susupension and during this addition pH is kept at 5.5 by simultaneous addition of 1% LiOH aqueous solution. After whole alumina sol is added, the product is filtered off and dried for 2 hours at 110° C. The dried product is calcined at 700° C. for half an hour. The product is a LiMn₂O₄ coated with lithium-containing aluminium oxide.

### Example 6

Coating of Cathode Material

600 g of LiMn₂O₄, SP35 Selectipur® from Merk, are dispersed in 3125 g water, and the suspension is heated to 45° C. and stirred. The stirring and temperature is kept till the end of reaction. 12 g of lithium acetate is dissolved in 250 g of 1% acetic acid solution separately. This solution is added into the susupension. By this addition the pH of the susupension become 5.0. Then 8.2% aluminum chloride hexahydrate aqueous solution is added slowly into the susupension and during this addition pH is kept at 5.0 by simultaneous addition of 1% LiOH aqueous solution. After whole aluminium chloride solution is added, the product is filtered and washed by water for several times to make chloride concentration of filtered water under 20 ppm. The product is dried for 2 hours at 110° C. and is calcined at 700° C. for half an hour The product is a LiMn₂O₄ coated with lithium-containing aluminium oxide.

Examination of the Chemical Stability

0.5 g of an LiMn₂O₄ coated as described in the examples above is added to 100 g of an aqueous acid solution (1000 ppm of acetic acid or 1000 ppm of HF). Over a period of 1 hour, the colour of the solution is observed and the acid stability is evaluated. For comparison, uncoated LiMn₂O₄, SP35 Selectipur® from Merck, is also examined.

Table 1 compares the results obtained on the uncoated and coated lithium-manganese spinels.

TABLE 1
Acid stability (0-colorless to 5-pale pink)

| | In 1000 ppm | |
|---|---|---|
| | CH₃COOH | In 1000 ppm HF |
| Uncoated LiMn₂O₄ (SP35) | 5 | 5 |
| Example 1 | ˜0 | ˜0 |
| Example 2 | 1-2 | 1-2 |
| Example 3 | 0 | 0 |
| Example 4 | ˜1 | ˜1 |
| Example 5 | 0 | 0 |
| Example 6 | 0 | 0 |

Colorless means that no manganese has gone into solution. These samples have a high acid stability. The uncoated sample displays immediate coloration of the solution and thus a poor resistance to acids. The LiMn₂O₄ coated according to the invention displays a better acid stability than the LiMn₂O₄ coated simply with metal oxides.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Lithium mixed oxide particles coated with at least one layer comprising a mixture of at least one alkali metal compound and at least one metal oxide.

2. Lithium mixed oxide particles according to claim 1, which are lithium intercalation or insertion compounds.

3. Lithium mixed oxide particles according to claim 1, wherein the particles are LiMn₂O₄, LiₓM_{y}Mn_{2-y}O₄, wherein M is Ti, Ge, Fe, Co, Cr, Cu, Li, Al, Mg, Ga, Zn, Ni or V, LiNiO₂, LiCoO₂, LiM′_{y}Co_{1-y}O₂, wherein M is Fe, B, Si, Cu, Ce, Y, Ti, V, Sn, Zr, La, Ni, Al, Mg, Cr and Mn, LiM_{y}Ni_{1-y}O₂, wherein M′ is Fe, Al, Ti, V, Co, Cu, Zn, B, Mg, Cr or Mn, LiₓWO₃ or LiₓTiS₂, 0.9≦x<1.1 and 0≦y≦1.

4. Lithium mixed oxide particles according to claim 1, wherein the metal oxides are Zr, Al, Si, Ti, La, Y, Sn, Zn, Mg, Ca or Sr or mixtures thereof.

5. Lithium mixed oxide particles according to claim 4, wherein the metal oxides are prepared from corresponding metal alkoxides.

6. Lithium mixed oxide particles according to claim 1, having a weight ratio of metal oxide to lithium mixed oxide particles of 0.01 to 20%.

7. Lithium mixed oxide particles according to claim 6, wherein the weight ratio of the metal oxide to lithium mixed oxide particles is 0.1 to 10%.

8. Lithium mixed oxide particles according to claim 1, wherein the alkali metals are lithium, sodium, potassium, rubidium or caesium.

9. Lithium mixed oxide particles according to claim 8, wherein the alkali metals are produced from corresponding salts.

10. Lithium mixed oxide particles according to claim 1, having a weight ratio of alkali metal to coated lithium mixed oxide particles of 0.01 to 10%.

11. Lithium mixed oxide particles according to claim 10, wherein the weight ratio of the alkali metal to lithium mixed oxide particles is 0.1 to 5%.

12. A cathode comprising coated lithium mixed oxide particles according to claims 1.

13. In a cathode comprising lithium mixed oxide particles and conventional support materials or auxiliaries, the improvement within the coated lithium mixed oxide particles are those according to claim 1.

14. In a cathode comprising lithium mixed oxide particles and conventional support materials or auxiliaries, the improvement within the lithium mixed oxide particles are those according to claim 2.

15. A process for producing singly or multiply coated lithium mixed oxide particles, comprising
a) supsending the particles in an organic solvent or water,
b) adding an alkali metal salt compound suspended in an organic solvent or water,
c) adding metal alkoxides, metal salts or metal sols dissolved in an organic solvent or water,
d) admixing the suspension with a hydrolysis solution and
e) optionally filtering off, drying and calcining coated particles.

16. A process for preparing lithium mixed oxide particles according to claim 1, comprising coating a lithium mixed oxide with an alkali metal and metal oxide.

17. A process for producing singly or multiply coated lithium mixed oxide particles according to claim 15, wherein c) and d) are carried out simultaneously.

18. A process according to claim 15, wherein alkali metal salts selected from the group consisting of lithium, sodium, potassium, rubidium and caesium acetates, acetylacetonates, lactates, oxalates, salicylates and stearates or inorganic salts selected from the group consisting of lithium, sodium, potassium, rubidium and caesium nitrate, sulfate or halogenides are used.

19. A process for producing singly or multiply coated lithium mixed oxide particles according to claim 15, wherein acids, bases, their aqueous preparation thereof or water are used as hydrolysis solution.

20. Lithium mixed oxide particles coated with alkali metal compounds and metal oxide obtainable by a process according to claim 15.

21. An electrochemical cell, comprising a cathod according to claim 12.
